(19) United States
(12) Patent Application Publication
(10) Pub. No.: US 2024/0011763 A1
(43) Pub. Date: Jan. 11, 2024

(54) QUANTUM SENSOR AND SYNXAPPS ARRAY

(71) Applicant: Demond Adams, Tamarac, FL (US)

(72) Inventor: Demond Adams, Tamarac, FL (US)

(21) Appl. No.: 18/190,094

(22) Filed: Mar. 26, 2023

Related U.S. Application Data
(60) Provisional application No. 63/367,643, filed on Jul. 5, 2022.

(51) Int. Cl. G01B 9/02

(52) U.S. Cl. CPC G01B 9/02051; G01B 9/02083; G01B 2290/55; G06N 10/40

(57) ABSTRACT

Similar to high-definition cameras, thermometers, microphones, and seismic sensors, Quantum Sensors are metric devices capable of converting analog signal diagnostics into quantized electrical impulses for data processing capabilities. However, unlike discrete bandwidth sensors digitally renormalized into frequency or temporal bit dependent amplitudes, Quantum Sensors can organize multiple multi-dimensional wavelength frequencies into a dense volumetric wavelength of Q-bit tomography information renormalized by its integration of a desired power wavelet function. This device functions as a time invariant, vector stabilized, and dimensionally independent signal filter for data capture and processing capabilities. Additionally, the extraction of a dimensional power wavelet function reduces ambient noise to signal compression interferences in signal spectroscopy analyzers. In this device a “twerk”, or transformation of a renormalized and quantized volumetric field gradient, is constructed as an anamorphic power density phase distribution detected by the Q-factor of a resonant flux capacitor, inductor, and semi-resistor circuit. Similar to layered RBG filter composites, Quantum Sensors can simulate holographic representations of any captured multi-dimensional data per discrete temporal amplitude, frequency modulation, or power wavelet interval function(s) into a SynXapps array of combinatoric data permutations.

### BACKGROUND OF THE INVENTION

### Field of the Invention

The embodiment of this invention relates to the field of electronics, and more specifically, to the field of signal detection and processing.

### Description of Related Art

As electronic circuits miniaturize beyond angstrom scales, high frequency current and inductive charge ratios increase noise interferences proportionately. Increases in charged flux mitigates electromagnetic noise interferences throughout signal processing circuits. Quantum inductive disturbances and parasitic capacitive charge fields are boosted by transistor gate switching near micro components and the incompatible cross talk of wireless broadcast signals. Furthermore, upsurges in gradient thermal radiation may interfere with circuit operation. These noise distorted properties incrementally produce errors in quantized data processing. To achieve accurate quantum computational processing without noisy signal interference, circuits must integrate a controlled current flow of input data without flawed or external noise interference during circuit operation.

Digital computer processing technologies compress multi-dimensional analog wave functions into a discrete one-dimensional series of amplitude bit information ordered by a temporal clocking device as input data. This compression technique references the congruent characteristics of an entire multi-dimensional wave function into a converted energy amplitude modulation. Power and frequency distributions of an analog wave function may combine to represent amplitude modulations, but during digital conversion, these discreate signals are indiscriminately merged into a one-dimensional stream of continuous bit information. Artificial noise aliasing may occur as a result of this data compression technique. Post data processing protocols are often employed to remove ambient noise below a desired threshold. Unfortunately, while removing unintended ambient noise, this technique also indiscriminately removes crucial wave function information.

Sensitive quantum computing processors require noise reduction circuitry. Analog to Digital signal conversion protocols and Fourier transformation techniques, implementing spectral analysis from sensor devices, are used to compress and remove noise interferences in input data. Quantum processors can perform multi-wavefunction data processing by sorting bit data into a multi-dimensional array of temporally distributed volumetric Q-bits. Q-bit analog compression data may represent a block of information indiscriminate from combinatoric ambient noise. Quantum input sensors must simultaneously detect and decode analog signals into a sparse array of discrete dimensional frequencies. During data processing, a Q-bit of data may represent a quantized wave function to be filtered by a correlating power wavelet function. To achieve these capabilities input devices such as quantum sensors must simultaneously perform time interval spectral analysis on multiple multi-dimensional power wavelet functions. Sorting static wave functions, using dimensional analysis from quantized input sensors, is an effective method of extracting random artificial ambient noise and discrete frequency interferences into combinatoric wavelet functions renormalized by convolutional multi-dimensional fluctuation permutations.

### BRIEF SUMMARY OF THE INVENTION

The embodiment presented provides a Quantum Sensor and SynXapps array, comprised of a Synchronized Inductor with a Normalized Capacitor (SINC) component, Reactive Inductor, Charge Capacitor, and Single Non-linear Anisotropic/Isotropic Lens (SNAIL), designed to limit the input interference of noise in a parasitic capacitive circuit and reduce inductive impulse spiking by applying quantized resonant frequencies dimensionally during signal detection and processing.

### DETAILED SUMMARY OF THE INVENTION

To liberate the quantization of a multi-dimensional power band in an analog signal, the regularized phase-shift of a multiplexed multi-dimensional frequency array must preserve its amplitude modulation by renormalizing the invariant current in a temporally and spatially conserved system. The proposed quantum sensor is designed to reduce ambient electromagnetic and thermodynamic field interferences of a Q-factor circuit while preserving signal integrity throughout the components described.

The described Quantum Sensor is comprised of two primary components stabilizing data into a semi-resistive quantum flux capacitor (SYNXAPPS ARRAY); a Synchronized Inductor and Normalized Capacitor (SINC) and a Single Nonlinear Anisotropic/Isotropic Lens (SNAIL). The SINC component stabilizes a quantized convolution capture of volumetric data relative the gradient lateral vector displacement of the device. The SNAIL component correlates a quantized convolution capture of volumetric data relative the gradient rotational curvature of the device. Finally, the semi-resistive quantum flux component (SYNXAPPS ARRAY) transforms every gradient amplitude signal by its dimensional vertex, linear, and/or field intensities of a volumetric convolutional power wavelet for data processing and wave function spectroscopy.

The SINC component transfers power density wavelet signals from/into an inductive core partially affixed to the base of a concaved SYNXAPPS ARRAY and is allowed to modify its power intensity by its linear translation near the approximation of its unfastened portion inserted thru a charged toroidal ring displaced away from the concaved SYNXAPPS ARRAY near the unfastened portion. As the device modifies its translation due to momentum the partially affixed inductive core modifies its translation near the SYNXAPPS ARRAY and the conductive ring modifying the intensity of power flux in a particular geometric capacitive region within the device. Trace leads of a convoluted capacitor region of semi-resistive photo-sensitive materials transfers this inductive reactance of current proportionally metering its translational movements.

The SNAIL component translates power density signals from a distributed field array thru a filtered semi-translucent geometric lens onto the semi-resistant quantum surface of the SYNXAPPS ARRAY. If the angular momentum of the power density signal translates a divergence relative the device, a conical augmented lens with a perforated geometric pattern will modify the gradient vector translation as a reactive power phase towards a correlating region. Trace leads within the semi-resistive photo-sensitive surface area can detect electromagnetic and quantum flux varieties into geometric regions.

The SYNXAPPS ARRAY is comprised of a semi-resistive quantum material with trace leads displaced throughout the concave cavity region. These trace leads are arranged to detect geometrically gradient flux disturbances in a Cartesian and Euclidean geometric field arrangement. A charged toroidal ring enveloped within a suspended transparent membrane is allowed to fluctuate according to a 2-dimensional column of vibrating air pressure within the device near the convoluted surface area of the semi-resistive quantum leads. Photon and thermal phase energy are permitted to discretely modify the flux capacitance of the semi-resistive quantum leads according to the 1-dimensional intensity of its photon energy. Furthermore, the self-induced volume of semi-resistive quantum trace leads are geometrically arranged to detect external electromagnetic flux disturbances.

### BRIEF DESCRIPTION OF THE DRAWINGS

FIG. 1. is a top view schematic composition diagram of the Quantum Sensor, SYNXAPPS ARRAY, Single Nonlinear Anisotropic/Isotropic Inductor (SNAIL), and Synchronized Inductor and Normalized Capacitor (SINC) according to an embodiment of this application.

FIG. 2. is a side view schematic composition diagram of the Quantum Sensor, SYNXAPPS ARRAY, Single Nonlinear Anisotropic/Isotropic Inductor (SNAIL), and Synchronized Inductor and Normalized Capacitor (SINC) according to an embodiment of this application.

### DETAILED DESCRIPTION OF DRAWINGS

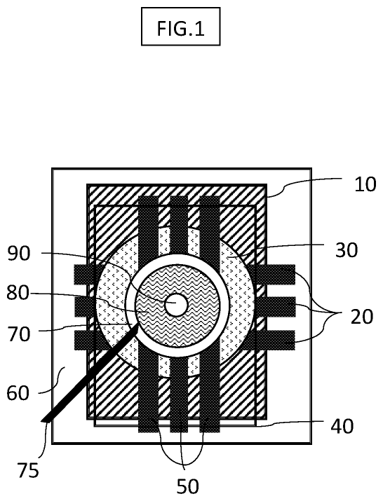

FIG. 1 shows a non-conductive concave surface manifold 10, with conductive trace pits geometrically etched in its surface area 20. A semi-resistive quantum material 30, doped with conductive and photo-sensitive impurities, is layered over the topology of the non-conductive manifold 10, and conductive trace pits 20. A transparent non-conductive surface manifold 40, with conductive trace pits are geometrically etched in its surface area 50, and layered over the topology of the semi-resistive quantum material 30. A transparent, flexible, and non-conductive membrane 60, embedded with a conductive ring 70 with a conductive trace lead 75 connected to the conductive ring 70 and both being elevated and affixed adjacent the transparent non-conductive surface manifold 40. A semi-translucent lens, with an inscribed geometric pattern 80, is elevated and affixed adjacent the transparent, flexible, and non-conductive membrane 60. An inductor core 90, is orthogonally centered thru the semi-translucent lens 80, thru the center of the conductive ring 70, thru the flexible membrane 60, thru the transparent surface 40, thru the semi-resistive photo-sensitive material 30, and affixed to the non-conductive concave manifold 10.

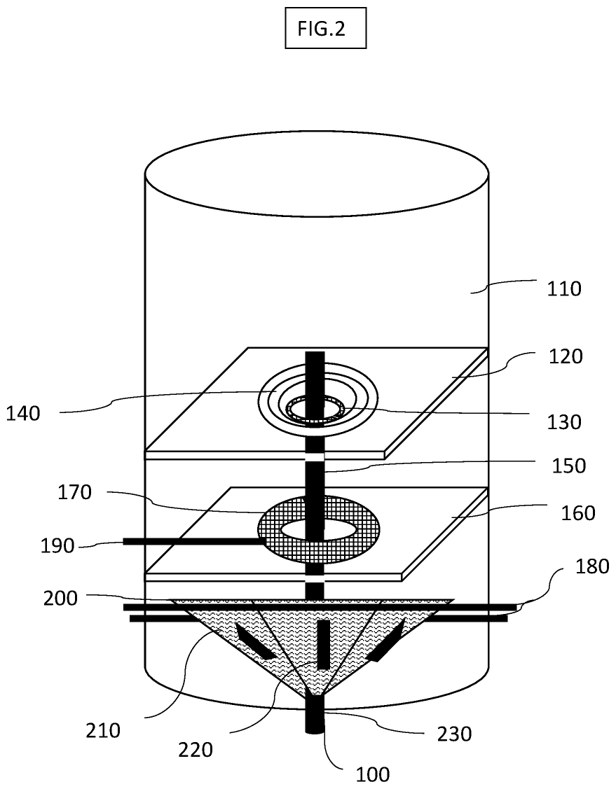

FIG. 2 shows a container 110, with an affixed semi-translucent lens 120 inserted and descended below the top region of the container 110, and an orthogonally centered inductor core 100, affixed at its base 230, is inserted thru the semi-translucent lens with a perforated and geometrically etched patterned opening 130. The semi-translucent lens is etched and perforated with a geometric pattern 140. A transparent, flexible, and non-conductive membrane 160, embedded with a conductive ring 170, is affixed to a conductive lead 190, and located adjacent a translucent lens 120. A non-conductive transparent surface manifold layered with a semi-resistive quantum material 200, etched with conductive trace pits 180, is affixed and located adjacent the flexible non-conductive membrane 160. A concave non-conductive surface area layered with a semi-resistive quantum material 210 and etched with conductive leads 220, are geometrically arranged and inserted thru the concave non-conductive surface 210.

1. A Quantum Sensor component, comprising;
a primary permeable semi-resistive quantum material infused with the doping of granulated conductive and photo-sensitive impurities distributed within the resistive material; and
a plurality of separated dissimilar permeable semi-resistive quantum material(s) infused with the doping of varied granulated conductive and photo-sensitive impurities distributed within each resistive material; and
the embedding of geometrically arranged conductive trace leads on the etched topology of a concave surface area layered with the said primary permeable semi-resistive quantum material and successive geometrically arranged conductive trace leads etched on the topology of a transparent planar surface area layered with said dissimilar plurality of permeable resistive materials; and
the suspended anchoring of a pliable transparent diaphragm membrane with a center affixed conductive toroidal ring attached to a conductive trace lead, located adjacent to the said transparent planar surface; and
the affixed anchoring of a semi-transparent lens, located adjacent to the said pliable transparent membrane, with etched and perforated geometric patterns; and
the partial anchoring of an orthogonal inductive wire inside the said concave surface area, thru the layers of said semi-resistive quantum material(s), thru the transparent layers of said planar surface area layered with the said dissimilar layers of permeable resistive materials, and thru the center of the said toroidal ring encased in the suspension of the pliable transparent membrane, and thru the said semi-transparent lens with etched and perforated geometric patterns.

2. A method of simultaneously capturing volumetric wavelength frequencies from a multi-dimensional sensor array to detect and process photonic, thermal, audio, pressure compression, magnetic, and phonon gradients of phased multi-dimensional energy fluctuations.

3. The method of stabilizing the angular momentum and geometric vector translation of a multi-dimensional sensor array device using an inductive core affixed to a said concave surface area, with a said semi-resistive quantum material, in a convolutional capacitor flux, and charge induced by a said toroidal conductive ring capturing volumetric combinatoric wavelength frequencies.
